(19) United States
(12) Patent Application Publication
(10) Pub. No.: US 2024/0409117 A1
(43) Pub. Date: Dec. 12, 2024

(54) AUTOMATED PARKING - EXIT SPOT TO LANE OF TRAFFIC FLOW

(71) Applicant: GM GLOBAL TECHNOLOGY OPERATIONS LLC, Detroit, MI (US)

(72) Inventor: Brian H Fiore, White Lake, MI (US)

(73) Assignee: GM GLOBAL TECHNOLOGY OPERATIONS LLC, Detroit, MI (US)

(21) Appl. No.: 18/333,034

(22) Filed: Jun. 12, 2023

(51) Int. Cl. B60W 60/00; B60W 40/04; B60W 50/10; G08G 1/01; G08G 1/09

(52) U.S. Cl. CPC B60W 60/001; B60W 40/04; B60W 50/10; G08G 1/0112; G08G 1/09; B60W 2400/00; B60W 2552/53

(57) ABSTRACT

Methods and systems are provided for controlling an automated exit of a vehicle from a parking spot that include sensors configured to obtain sensor data pertaining to the parking spot and lanes of a roadway in proximity to the parking spot, including a respective direction of flow of traffic; and processors coupled to the sensors and configured to at least facilitate selecting a lane for the vehicle to enter upon exiting the parking spot, based at least in part on the direction of flow of traffic; selecting a turn for the vehicle to make such that the vehicle is travelling in the same direction as the direction of flow of traffic; and executing the automated exit of the vehicle from the parking spot into the selected lane by making the selected turn of the vehicle into the selected lane.

### TECHNICAL FIELD

The technical field generally relates to vehicles and, more specifically, to systems and methods for controlling automated exit of vehicles from parking spots.

### BACKGROUND

Certain vehicles today have systems that provide automated control of one or more features of vehicles. However, existing techniques may not always provide optimal results, for example when exiting a parking spot into traffic.

Accordingly, it is desirable to provide improved methods and systems for provided automatic control of a vehicle exiting a parking spot into traffic. Furthermore, other desirable features and characteristics of the present invention will become apparent from the subsequent detailed description of the invention and the appended claims, taken in conjunction with the accompanying drawings and this background of the invention.

### SUMMARY

In an exemplary embodiment, a method for controlling an automated exit of a vehicle from a parking spot, the method including obtaining, via one or more sensors, sensor data pertaining to the parking spot in which the vehicle is parked and a plurality of lanes of a roadway in proximity to the parking spot, including a respective direction of flow of traffic for each of the plurality of lanes: selecting, via one or more processors, a selected lane of the plurality of lanes for the vehicle to enter into upon exiting the parking spot, based at least in part on the sensor data, including the direction of flow of traffic of the selected lane: selecting, via the one or more processors, a selected turn for the vehicle to make such that the vehicle is travelling in the same direction as the direction of flow of traffic of the selected lane as the vehicle enters the selected lane upon exiting the parking spot: and executing, via instructions provided by the one or more processors, the automated exit of the vehicle from the parking spot into the selected lane by making the selected turn of the vehicle into the selected lane, such that the vehicle is moving in the direction of flow of traffic of the selected lane as it enters the selected lane.

Also in an exemplary embodiment, the steps of selecting the selected lane and selecting the selected turn are performed based at least in part on information as to typical traffic flows in the plurality of lanes, including a jurisdiction in which the vehicle is operated.

Also in an exemplary embodiment, the steps of selecting the selected lane and selecting the selected turn are performed based at least in part on inputs provided by a user of the vehicle pertaining to a type of parking spot in which the vehicle is parked, including a current angle and a current direction in which the vehicle is parked with respect to the roadway.

Also in an exemplary embodiment, the steps of selecting the selected lane and selecting the selected turn are performed based at least in part on inputs provided by a user of the vehicle pertaining to as to a preferred lane for the vehicle to enter upon exiting the parking spot.

Also in an exemplary embodiment, the steps of selecting the selected lane and selecting the selected turn are performed based at least in part on a geographic database stored in a computer memory as to the plurality of lanes of the roadway.

Also in an exemplary embodiment, the step of obtaining the sensor data includes obtaining, via the one or more sensors, the sensor data including vision data as to the plurality of lanes: and the steps of selecting the selected lane and selecting the selected turn are performed based at least in part on the vision data as to the plurality of lanes.

Also in an exemplary embodiment, the method further includes determining, via the one or more processors, the direction of flow of traffic of each of the plurality of lanes using the vision data.

Also in an exemplary embodiment, the method further includes determining, via the one or more processors, lane markings for the plurality of lanes from the vision data: wherein the steps of selecting the selected lane and selecting the selected turn are performed based at least in part on the lane markings from the vision data.

Also in an exemplary embodiment, the method further includes identifying, via the one or more processors, traffic signs for the plurality of lanes from the vision data: wherein the steps of selecting the selected lane and selecting the selected turn are performed based at least in part on the traffic signs from the vision data.

In another exemplary embodiment, a system is provided for controlling an automated exit of a vehicle from a parking spot, the system including one or more sensors configured to obtain sensor data pertaining to the parking spot in which the vehicle is parked and a plurality of lanes of a roadway in proximity to the parking spot, including a respective direction of flow of traffic for each of the plurality of lanes: and one or more processors coupled to the one or more sensors and configured to at least facilitate selecting a selected lane of the plurality of lanes for the vehicle to enter into upon exiting the parking spot, based at least in part on the sensor data, including the direction of flow of traffic of the selected lane: selecting a selected turn for the vehicle to make such that the vehicle is travelling in the same direction as the direction of flow of traffic of the selected lane as the vehicle enters the selected lane upon exiting the parking spot: and executing, via instructions provided by the one or more processors, the automated exit of the vehicle from the parking spot into the selected lane by making the selected turn of the vehicle into the selected lane, such that the vehicle is moving in the direction of flow of traffic of the selected lane as it enters the selected lane.

Also in an exemplary embodiment, the one or more processors are further configured to at least facilitate selecting the selected lane and selecting the selected turn based at least in part on information as to typical traffic flows in the plurality of lanes, including a jurisdiction in which the vehicle is operated.

Also in an exemplary embodiment, the one or more processors are further configured to at least facilitate selecting the selected lane and selecting the selected turn based at least in part on inputs provided by a user of the vehicle pertaining to a type of parking spot in which the vehicle is parked, including a current angle and a current direction in which the vehicle is parked with respect to the roadway.

Also in an exemplary embodiment, the one or more processors are further configured to at least facilitate selecting the selected lane and selecting the selected turn based at least in part on inputs provided by a user of the vehicle pertaining to as to a preferred lane for the vehicle to enter upon exiting the parking spot.

Also in an exemplary embodiment, the one or more processors are further configured to at least facilitate selecting the selected lane and selecting the selected turn based at least in part on a geographic database stored in a computer memory as to the plurality of lanes of the roadway.

Also in an exemplary embodiment, the one or more sensors are configured to obtain the sensor data including vision data as to the plurality of lanes: and the one or more processors are further configured to at least facilitate selecting the selected lane and selecting the selected turn based at least in part on the vision data as to the plurality of lanes.

Also in an exemplary embodiment, the one or more processors are further configured to at least facilitate determining the direction of flow of traffic of each of the plurality of lanes using the vision data.

Also in an exemplary embodiment, the one or more processors are further configured to at least facilitate identifying lane markings for the plurality of lanes from the vision data: and selecting the selected lane and selecting the selected turn based at least in part on the lane markings from the vision data.

Also in an exemplary embodiment, the one or more processors are further configured to at least facilitate identifying traffic signs for the plurality of lanes from the vision data: and selecting the selected lane and selecting the selected turn based at least in part on the traffic signs from the vision data.

In another exemplary embodiment, a vehicle is provided that includes a body: a drive system configured to generate movement of the body: one or more sensors disposed on or within the body and configured to obtain sensor data for the vehicle pertaining to a parking spot in which the vehicle is parked and a plurality of lanes of a roadway in proximity to the parking spot, including a respective direction of flow of traffic for each of the plurality of lanes: and one or more processors that are disposed within the body and that is coupled to the one or more sensors, the one or more processors coupled to the one or more sensors and configured to at least facilitate selecting a selected lane of the plurality of lanes for the vehicle to enter into upon exiting the parking spot, based at least in part on the sensor data, including the direction of flow of traffic of the selected lane: selecting a selected turn for the vehicle to make such that the vehicle is travelling in the same direction as the direction of flow of traffic of the selected lane as the vehicle enters the selected lane upon exiting the parking spot: and executing, via instructions provided by the one or more processors, an automated exit of the vehicle from the parking spot into the selected lane by making the selected turn of the vehicle into the selected lane, such that the vehicle is moving in the direction of flow of traffic of the selected lane as it enters the selected lane.

Also in an exemplary embodiment, the one or more processors are further configured to at least facilitate selecting the selected lane and selecting the selected turn based at least in part on information as to typical traffic flows in the plurality of lanes, including a jurisdiction in which the vehicle is operated.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle having a control system for controlling the vehicle's automated exit out of a parking spot, in accordance with exemplary embodiments:

FIG. 2 is a flowchart of a process for controlling a vehicle's automated exit out of a parking spot, and that can be implemented in connection with the vehicle of FIG. 1, in accordance with exemplary embodiments:

FIG. 3 is a diagram of an exemplary implementation of FIG. 2, depicting a display screen for inputs of a user of a vehicle as to a type of parking spot the vehicle is exiting: and

FIG. 4 is a diagram of another exemplary implementation of FIG. 2, depicting the vehicle in its parking spot and nearby lanes for exit of the vehicle out of the parking spot, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

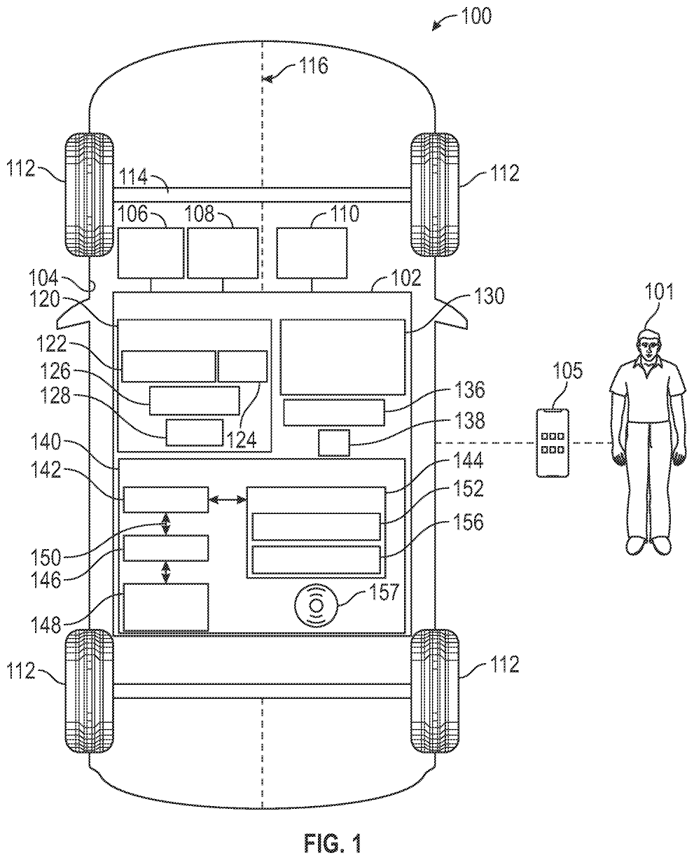

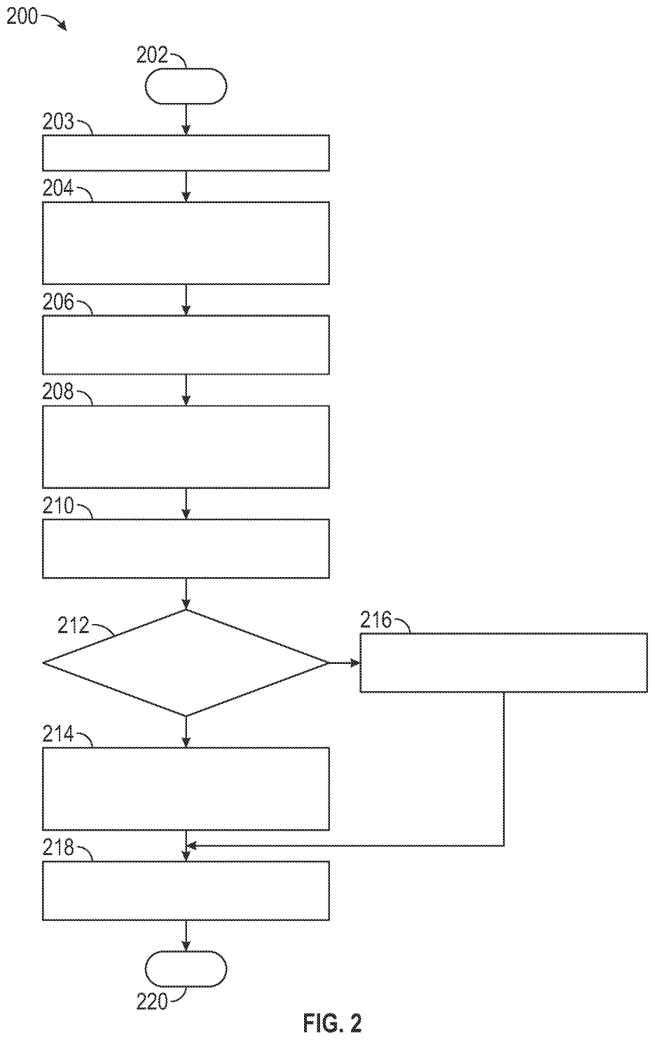

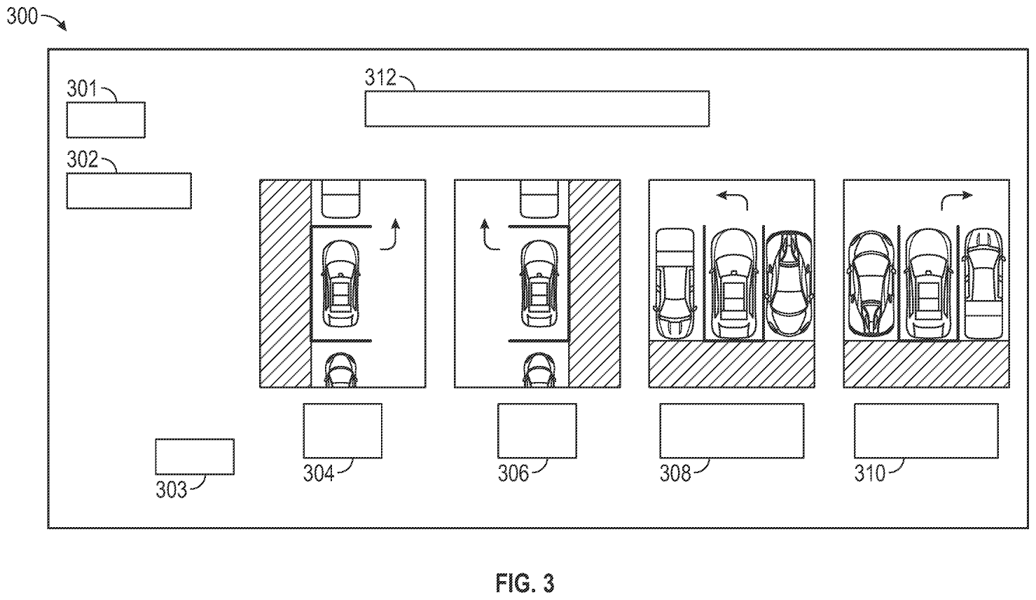

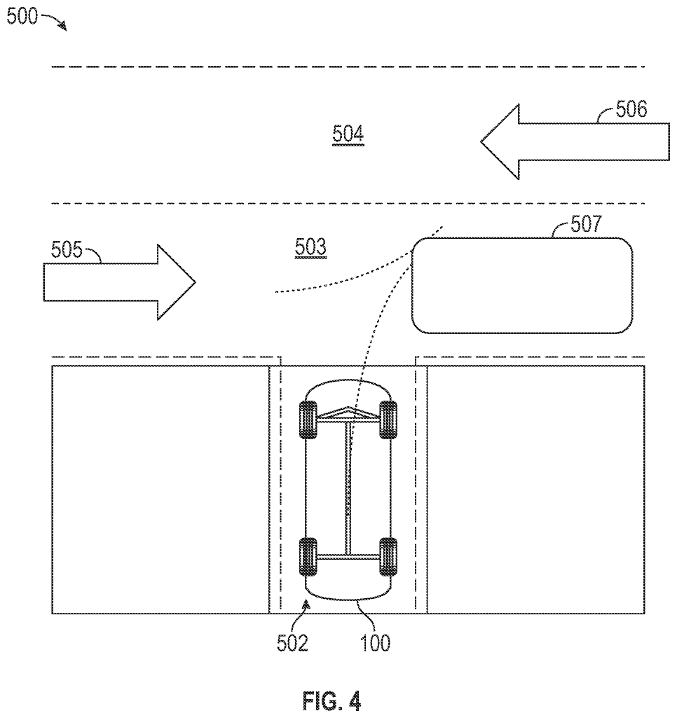

FIG. 1 illustrates a vehicle 100. In various embodiments, and as described below, the vehicle 100 includes a control system 102 for controlling the vehicle 100′s automated exit out of a parking spot in which the vehicle 100 is parked, in accordance with an exemplary embodiment. In various embodiments, the vehicle 100 is parked in a parking spot along a roadway. Also in various embodiments, the control system 102 utilizes user inputs and information regarding nearby traffic lanes and/or traffic pattens of the roadway in planning and executing the exit from the vehicle 100 from the parking spot into one of the traffic lanes of the roadway, including as set forth in greater detail in the process of FIG. 2, the implementations of FIGS. 3 and 4, and the descriptions provided herein.

As depicted in FIG. 1, in certain embodiments, the vehicle 100 communicates with an electronic device 105 (e.g., a keyfob, remote control, smart phone, and/or other electronic device) of a user 101 of the vehicle 100 (e.g., a driver, operator, or other user) of the vehicle 100. In certain embodiments, the vehicle utilizes inputs from the user 101 and/or communications with the electronic device 105 of the user 101 in executing the steps of the process of FIG. 2 and the implementations of FIGS. 3 and 4.

In certain embodiments, the user 101 may be disposed inside the vehicle 100 (e.g,. as a driver or passenger inside a cabin of the vehicle 100). In certain other embodiments, the user 101 may be temporarily located outside the vehicle 100, and may be waiting to enter the vehicle 100 until the vehicle 100 has exited the parking spot (e.g., in the case of a tight parking spot in which it may be difficult to fully open and close the doors of the vehicle 100).

In various embodiments, the vehicle 100 comprises an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 100 may also comprise a motorcycle or other vehicle, such as aircraft, spacecraft, watercraft, and so on, and/or one or more other types of mobile platforms (e.g., a robot and/or other mobile platform).

In certain embodiments, the vehicle 100 may comprise one or more different types of electric vehicles, such as a fully electric vehicle or a hybrid electric vehicle. However, this may vary in other embodiments, for example in which the vehicle 100 may be powered via gas combustion, solar power, and/or one or more other types of power sources.

In certain embodiments, the vehicle 100 may comprise an autonomous or semi-autonomous vehicle, for example in which vehicle control (including acceleration, deceleration, braking, and/or steering) is automatically planned and executed by the control system 102, in whole or in part, at least certain conditions (e.g., from entering and exiting parking spot). In certain embodiments, the vehicle 100 may also be operated in whole or in part by a human driver under certain other conditions.

In the depicted embodiment, the vehicle 100 includes a body 104 that is arranged on a chassis 116. The body 104 substantially encloses other components of the vehicle 100. The body 104 and the chassis 116 may jointly form a frame. The vehicle 100 also includes a plurality of wheels 112. The wheels 112 are each rotationally coupled to the chassis 116 near a respective corner of the body 104 to facilitate movement of the vehicle 100. In one embodiment, the vehicle 100 includes four wheels 112, although this may vary in other embodiments (for example for trucks and certain other vehicles).

A drive system 110 is mounted on the chassis 116, and drives the wheels 112, for example via axles 114. The drive system 110 preferably comprises a propulsion system. In certain exemplary embodiments, the drive system 110 comprises an internal combustion engine and/or an electric motor/generator, coupled with a transmission thereof. In certain embodiments, the drive system 110 may vary, and/or two or more drive systems 110 may be used. By way of example, the vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

As noted above, in certain embodiments, the vehicle 100 includes one or more functions controlled automatically via the control system 102. In certain embodiments, the vehicle 100 comprises an autonomous vehicle, such as a semi-autonomous vehicle or a fully autonomous vehicle, for automated control of the drive system 110 and/or other vehicle components, at least under certain conditions (e.g., for parking). However, a human driver may control the drive system 110 in various other conditions in certain embodiments.

As depicted in FIG. 1, the vehicle 100 also includes a braking system 106 and a steering system 108 in various embodiments. In exemplary embodiments, the braking system 106 controls braking of the vehicle 100 using braking components that are controlled via inputs provided by a driver (e.g., via a braking pedal in certain embodiments) and/or automatically via the control system 102. Also in exemplary embodiments, the steering system 108 controls steering of the vehicle 100 via steering components (e.g., a steering column coupled to the axles 114 and/or the wheels 112) that are controlled via inputs provided by a driver (e.g., via a steering wheel in certain embodiments) and/or automatically via the control system 102.

In the embodiment depicted in FIG. 1, in certain embodiments, the control system 102 is coupled to the braking system 106, the steering system 108, and the drive system 110.

Also as depicted in FIG. 1, in various embodiments, the control system 102 includes a sensor array 120, a display 130, a navigation system 136, a transceiver 138, and a controller 140.

In various embodiments, the sensor array 120 includes various sensors that collect sensor data, including for use by the control system 102 in controlling exit of the vehicle 100 from the parking spot. As depicted in FIG. 1, in various embodiments the sensor array 120 includes one or more ultrasonic sensors 122, input sensors 124, vision sensors 126, and radar sensors 128. Also in various embodiments as depicted in FIG. 1, the sensor array 120 may also include one or more other sensors.

In various embodiments, the ultrasonic sensors 122 obtain sensor data as to the parking of the vehicle 100, its position in a parking spot and its surrounding environment (e.g., including other vehicles), and traffic lanes (and in certain embodiments, traffic flow) for potential exit of the vehicle 100 out of the parking spot. In certain embodiments, these and other types of sensor data may also be obtained via the vision sensors 126 (e.g., cameras) and/or radar sensors 128.

In various embodiments, the input sensors 124 detect inputs from a user 101 of the vehicle 100 (e.g., from a driver or other user 101 of the vehicle 100). In certain embodiments, the input sensors 124 detect user inputs as to a request to initiate the automatic parking (or parking exit) functionality, along with a type of parking spot the vehicle 100 is about to exit, and as to a preferred lane of traffic (if any) that the user 101 would like for the vehicle 100 to exit into. In certain embodiments, such inputs may also be ascertained via communication with the electronic device 105 of the user 101. In addition, in certain embodiments, the input sensors 124 may also pertain to the user 101′s engagement of one or more other vehicle devices and/or systems, such as left turn or right turn blinkers, a steering wheel, an accelerator pedal, a brake pedal and so on.

In various embodiments, the display 130 provides information for the user 101 of the vehicle 100, including as to parking spot of the vehicle 100 and lanes of traffic to which the vehicle 100 may exit. In various embodiments, the display 130 provides a plurality of different options or choices as to the parking spot and/or lanes, and receives inputs from the user 101 in response thereto.

Also in various embodiments, the navigation system 136 (also referred to herein as a “location system”) is configured to obtain and/or generate data as to a position and/or location in which the vehicle 100 is located and/or is travelling, and in certain embodiments including conditions surrounding the position and/or location (e.g., as to speed limits, traffic flows and directions thereof, road conditions, and/or other values). In certain embodiments, the navigation system 136 comprises and/or or is coupled to a satellite-based network and/or system, such as a global positioning system (GPS) and/or other satellite-based system.

In various embodiments, the transceiver 138 receives information regarding the vehicle 100, the parking spot of the vehicle 100, and/or the lanes of travel to which the vehicle 100 may exit from the parking spot. In certain embodiments, the transceiver 138 receives user inputs (e.g., as to the parking location and user's desire as to a lane of exit) from the electronic device 105 of the user 101. In addition, in certain embodiments, the transceiver 138 also receives information regarding the parking spot and/or potential lanes of exit, such as traffic flow and direction thereof, speed limits, traffic conditions, and/or other conditions at the location (e.g., in concert with the navigation system 136 in certain embodiments).

In various embodiments, the controller 140 is coupled to the sensor array 120, display 130, navigation system 136, and transceiver 138. Also in various embodiments, the controller 140 comprises a computer system, and includes a processor 142, a memory 144, an interface 146, a storage device 148, and a computer bus 150. In various embodiments, the controller (or computer system) 140 controls automated exit of the vehicle 100 from the parking spot into a lane of traffic, based on the sensor data from the sensor array 120, navigation system data form the navigation system 136, and/or other data received (e.g., via the transceiver 138). In various embodiments, the controller 140 provides these and other functions in accordance with the steps of the processes and implementations depicted in FIGS. 2-4 and as described further below in connection therewith.

In various embodiments, the controller 140 (and, in certain embodiments, the control system 102 itself) is disposed within the body 104 of the vehicle 100. In one embodiment, the control system 102 is mounted on the chassis 116. In certain embodiments, the controller 140) and/or control system 102 and/or one or more components thereof may be disposed outside the body 104, for example on a remote server, in the cloud, or other device where image processing is performed remotely.

It will be appreciated that the controller 140 may otherwise differ from the embodiment depicted in FIG. 1. For example, the controller 140 may be coupled to or may otherwise utilize one or more remote computer systems and/or other control systems, for example as part of one or more of the above-identified vehicle 100 devices and systems.

In the depicted embodiment, the computer system of the controller 140 includes a processor 142, a memory 144, an interface 146, a storage device 148, and a bus 150. The processor 142 performs the computation and control functions of the controller 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the controller 140 and the computer system of the controller 140, generally in executing the processes described herein, such as the processes and implementations depicted in FIGS. 2-4 and as described further below in connection therewith.

The memory 144 can be any type of suitable memory. For example, the memory 144 may include various types of dynamic random access memory (DRAM) such as SDRAM, the various types of static RAM (SRAM), and the various types of non-volatile memory (PROM, EPROM, and flash). In certain examples, the memory 144 is located on and/or co-located on the same computer chip as the processor 142. In the depicted embodiment, the memory 144 stores the above-referenced program 152 along with one or more map databases 156 (e.g., of the traffic lanes in proximity to the parking spot).

The bus 150 serves to transmit programs, data, status and other information or signals between the various components of the computer system of the controller 140. The interface 146 allows communication to the computer system of the controller 140, for example from a system driver and/or another computer system, and can be implemented using any suitable method and apparatus. In one embodiment, the interface 146 obtains the various data from the sensor array 120 and/or the navigation system 136. The interface 146 can include one or more network interfaces to communicate with other systems or components. The interface 146 may also include one or more network interfaces to communicate with technicians, and/or one or more storage interfaces to connect to storage apparatuses, such as the storage device 148.

The storage device 148 can be any suitable type of storage apparatus, including various different types of direct access storage and/or other memory devices. In one exemplary embodiment, the storage device 148 comprises a program product from which memory 144 can receive a program 152 that executes one or more embodiments of the processes and implementations of FIGS. 2-4 and as described further below in connection therewith. In another exemplary embodiment, the program product may be directly stored in and/or otherwise accessed by the memory 144 and/or a secondary storage device (e.g., disk 157), such as that referenced below.

The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 140 may also otherwise differ from the embodiment depicted in FIG. 1, for example in that the computer system of the controller 140 may be coupled to or may otherwise utilize one or more remote computer systems and/or other control systems.

With reference to FIG. 2, a flowchart is provided of a process 200 for controlling automated exit of a vehicle from a parking spot, in accordance with exemplary embodiments. In various embodiments, the process 200 may be implemented in connection with the vehicle 100, the control system 102 thereof, and/or other components and/or devices as described above in connection with FIG. 1.

As depicted in FIG. 2, the process 200 begins at step 202 when the vehicle 100 of FIG. 1 is started when the vehicle 100 begins operation at a time in which the vehicle 100 has been parked in a parking spot along a roadway. In various embodiments, the process 200 continues until the vehicle 100 has successfully exited the parking spot into a lane of the roadway.

In various embodiments data is obtained (step 203). In various embodiments, sensor data is obtained from the various sensors of the sensor array 120 of FIG. 1. In various embodiments, sensor data is obtained via the ultrasonic sensors 122, vision sensors 126, and/or radar sensors 128 of FIG. 1 as to a parking spot in which the vehicle 100 is located along with nearby lanes of traffic. In certain embodiments, such information may also be obtained via the navigation system 136 and/or transceiver 138 of FIG. 1, and/or from the map database 156 of FIG. 1. In addition, in certain embodiments, user inputs may also be obtained from the input sensors 124 and/or the user 101′s electronic device 105 of FIG. 1, for example as to the user's requests pertaining to operation of the vehicle 100 and/or for exiting the parking spot into a lane of traffic.

In various embodiments, a determination is made as to whether the vehicle 100 is parked in a parking spot (step 204). In various embodiments, this determination is made by the processor 142 of FIG. 1 based on the sensor data of step 203. Specifically, in certain embodiments, the processor 142 determines that the vehicle 100 is parked in a parking spot along a roadway based on the sensor data obtained via the ultrasonic sensors 122, vision sensors 126, and/or radar sensors 128 of FIG. 1, or in certain embodiments via location data obtained via the navigation system 136, transceiver 138, and/or map database 156 of FIG. 1.

Also in various embodiments, automatic parking functionality is initiated (step 206). In certain embodiments, automatic parking functionality (e.g., including for exiting a parking spot) for the vehicle 100 is initiated via the processor 142 based on inputs from the user 101 of FIG. 1, for example as detected via the data of step 203. In certain embodiments, the user inputs are detected via one or more input sensors 124 of FIG. 1 based on the user 101's engagement of one or more input devices, such as an automated parking button, display screen, or the like (e.g., as part of the display 130 and/or as part of a dashboard or center console of the vehicle 100). In certain other embodiments, the user inputs may also be obtained from the user 101 via the electronic device 105 of FIG. 1 (e.g., a smart phone, key fob, or remote control of the user 101).

In various embodiments, exit park options are displayed (step 208). Specifically, in various embodiments, various options are displayed for the user 101 of FIG. 1 as to (a) a description of the current parking spot scenario and/or (b) the user 101′s preferences for exiting the parking spot into a lane of traffic. In various embodiments, the exit park options are presented for the user 101 on the display 130 of FIG. 1 (e.g., on a display screen thereof) in accordance with instructions provided by the processor 142 of FIG. 1. Alternatively, in certain embodiments, the exit park options may instead be presented for the user 101 on the user 101′s electronic device 105 of FIG. 1 (e.g., via a smart phone app or other interface with a smart phone, keyfob, remote control, or other electronic device 105 of the user 101) in accordance with instructions provided by the processor 142.

With reference to FIGS. 3 and 4, exemplary exit park options of step 208 are illustrated in accordance with exemplary embodiments.

First, as depicted in FIG. 3, a first display screen 300 is provided that pertains to a type of parking spot from which the vehicle 100 is exiting, along with selections for activation of the automated exit from the parking spot, in accordance with an exemplary embodiment. As depicted in FIG. 3, the user 101 is provided with the opportunity to choose the mode of operation for the automated parking (and exiting) functionality, including (i) a first mode 301 (e.g., “Park”, namely, to park the vehicle 100 in a parking spot): (ii) a second mode 302 (e.g., “Exit Space”, namely, for the vehicle 100 to exit the parking spot); and (iii) a third model 303 (e.g., “Exit”, namely, to exit the automated parking functionality).

In addition, in certain embodiments, a message 312 is provided for the user 101 on a top portion of the first display screen 300. For example, in an exemplary embodiment in which the user 101 has initiated the second mode 302 (“Exit Space”), the message 312 provides language along the lines of the following: “What type of space are you exiting?”.

Also in various embodiments during which the second mode 302 (“Exit Space”) has been initiated, the first display screen 300 also provides various options 304-310 for the user 101 to select with accompanying descriptions of potential scenarios describing the current parking situation. For example, in the depicted illustration, the options include the following: (i) a first option 304 illustrating a “Parallel Left” parking scenario in which the vehicle 100 is parallel parked, parallel to traffic, on the left side of a roadway: (ii) a second option 306 illustrating a “Parallel Right” parking scenario in which the vehicle 100 is parallel parked, parallel to traffic, on the right side of a roadway: (iii) a third option 308 illustrating a “Perpendicular Left” parking scenario in which the vehicle 100 is parked perpendicular to traffic on the left side of the roadway: and (iv) a fourth option 310 illustrating a “Perpendicular Right” parking scenario in which the vehicle 100 is parked perpendicular to traffic on the right side of the roadway.

While FIG. 3 depicts an exemplary options with respect to the parking spot scenario in accordance with certain embodiments, it will be appreciated that in various embodiments the process 200 may be performed with or without presenting some or all of these options for the user 101. For example, in various different embodiments, the processor 142 of FIG. 1 may select the appropriate parking spot exit strategy with or without user inputs as to FIG. 3 (e.g., any may instead obtain the information from other sources in certain embodiments).

In various embodiments (e.g., in which options of FIG. 3 are presented to the user 101), user inputs are obtained (step 210). In various embodiments, during step 210, the user 101 of FIG. 1 selects an identification of the parking spot scenario for the vehicle 100. Specifically, in various embodiments, the user 101 provides inputs as to the classification of the parking spot scenario, including a current angle and a current direction in which the vehicle 100 is parked with respect to the roadway (e.g., from options provided in the first display screen 300 of FIG. 3). In various embodiments, the user inputs are obtained via the input sensors 124 and/or the electronic device 105 of FIG. 1, for example as described above. In certain embodiments, user inputs as to a preferred lane for the vehicle 100 to turn into upon exiting the parking spot may also be obtained. In addition, in certain embodiments, one or more other types of user inputs may be obtained, for example via as to the user 101 turning on a right turn or left turn directional signal as an indication of the desired direction of travel for the user 101, and so on.

In various embodiments, a determination is made as to whether additional direction data exists (step 212). Specifically, in various embodiments, determinations are made as to whether the vehicle 100 has access to data from vision sensors 126 as part of a front camera module (FCP) or other devices and/or systems, map databases 156, and/or other sources regarding a roadway along which the vehicle 100 is parked, such as including lanes of traffic, lane markers, traffic signs, directions of traffic in the lanes, direction of traffic, volume of traffic, and speed of traffic in the lanes, information as to whether the roadway is a one-way street or has lanes in multiple directions, traffic patterns, and the like.

In various embodiments, if it is determined in step 212 that additional direction data does not exist, then the process proceeds to step 214. In various embodiments, during step 214, an automated exit path for the vehicle 100 is determined using standard traffic patterns for the vehicle 100′s exit out of the parking spot and into a lane of traffic of the roadway. In various embodiments, during step 214, the processor 142 selects the automated exit path based on a direction of movement of traffic in the lanes of the roadway, and particularly the lane closest to the vehicle 100 and its parking spot. In various embodiments, the automated exit path comprises a selected lane for the vehicle 100 to enter along with a selected turn for the vehicle 100 to make such that the vehicle 100 is facing and travelling in the same direction as the traffic flow of the selected lane as the vehicle 100 enters the selected lane upon exiting the parking spot.

In certain embodiments, the determinations of step 214 are based at least in part on the jurisdiction in which the vehicle 100 is being operated, including whether vehicles 100 typically are operated in a right lane (e.g., in a right lane jurisdiction such as the United States and various other right lane jurisdictions) or, alternatively, in a left lane (e.g., in a left lane jurisdiction such as the United Kingdom and various other left lane jurisdictions).

Also in certain embodiments, the determinations of step 214 are also based at least in part on location of the parking spot in which the vehicle 100 is parked, and particularly as to which of the options 304-310 of FIG. apply to the current parking scenario for the vehicle 100. In various embodiments, this may be obtained via user inputs of step 210 and/or via the data of step 203.

In various embodiments, the processor 142 of FIG. 1 selects the automated exit path based on a combination of step typical traffic patterns and the current scenario described above. Specifically, in various embodiments, the processor 142 selects the automated exit path for the vehicle 100 to exit the parking spot into a particular lane of the roadway while moving in the same direction as the flow of traffic in the particular lane of the roadway. In addition, in also in certain embodiments, the processor 142 selects the automated exit path such that the vehicle 100 enters the particular lane of the roadway that is closest to the parking spot while moving in the same direction as the flow of traffic in that particular lane.

With reference to FIG. 4, an illustration 500 is provided showing the vehicle 100 parked in a parking spot 502 along a roadway in proximity to a first lane 503 and a second lane 504 of traffic. As depicted in FIG. 4, in this particular illustration the first lane 503 has a first direction of traffic flow 506 from left to right, whereas the second lane 504 has a second direction of traffic flow 506 from right to left. In various embodiments, during step 214 of FIG. 2, the automated exit path in this scenario would be for the vehicle 100 to turn right into the first lane 503 in the same direction as the first direction of traffic flow 505 toward a target final spot 507 for entry into the first lane 503 of traffic upon exiting the parking spot 502. It will be appreciated that in various other embodiments (e.g., corresponding to different options of FIG. 3, different jurisdictions such as for left lane travel, and/or other different traffic patterns) the automated exit path may differ, but would still in various embodiments provide for the vehicle 100 to enter into a nearest lane of traffic while moving in the same direction as the traffic flow in that lane of traffic.

In addition, in certain embodiments, the processor 142 selects the automated exit path such that the vehicle 100 enters an optimal or selected lane (e.g., in certain embodiments, the nearest lane) while also travelling in the same direction as the flow of traffic in the selected lane. Accordingly, and with reference back to FIG. 4, in various embodiments, the processor 142 may select the desired lane (e.g., the first lane 503 or the second lane 504) for entry of the vehicle 100, with the automated exit path including a turn of the vehicle 100 such that the vehicle 100 is travelling in the same direction as the traffic flow (e.g., traffic flow: 505 or traffic flow 506, respectively) as the selected lane as the vehicle 100 enters the selected lane upon exiting the parking spot 502. In certain embodiments, the processor 142 may similarly take into account other user inputs, such as a user's preference as to a preferred lane for the vehicle 100 to turn into and/or the user 101 turning on a right turn or left turn directional signal as indication of the desired direction of travel for the user 101, and so on, provided that the processor 142 is able to position the vehicle 100 facing the same direction as the flow of traffic as the lane upon entry by the vehicle 100, and so on.

In various embodiments, the process 200 then proceeds to step 220, described further below.

With reference back to step 212, in various embodiments, if it is instead determined in step 212 that additional direction data does exist, then the process proceeds instead to step 216. In various embodiments, during step 216, the processor 142 of FIG. 1 also utilizes additional data, for example from the vision sensors 126, navigation system 136, and map database 156, in order to select an optimal automated exit path for the vehicle 100. Specifically, in various embodiments, during step 216, the processor 142 utilizes the data described above from step 214 (e.g., typical traffic direction, current jurisdiction, user inputs, and the like) in combination with the additional data from the vision sensors 126, navigation system 136, and map database 156 in order to select an optimized lane for the vehicle 100 to enter into as well as the direction of travel into the optimized lane. In various embodiments, the automated exit path comprises a selected lane (i.e., the optimized lane) for the vehicle 100 to enter along with a selected turn for the vehicle 100 to make such that the vehicle 100 is facing and travelling in the same direction as the traffic flow of the selected lane as the vehicle 100 enters the selected lane upon exiting the parking spot.

In various embodiments, as part of the additional data utilized in step 216, the processor 142 uses additional information such as lanes of traffic, lane markers, traffic signs, directions of traffic in the lanes, direction of traffic, volume of traffic, and speed of traffic in the lanes, information as to whether the roadway is a one-way street or has lanes in multiple directions, along with traffic patterns and the like, in optimizing the particular lane to which the vehicle 100 is to enter into upon exiting the parking spot. For example, in certain embodiments, the processor 142 selects an optimized lane as representing a closest lane to the parking spot and/or a closest lane to the parking spot that is consistent (e.g., in terms of direction, traffic flow, and the like) with the user inputs and/or that is consistent with a relatively easy and effortless maneuver of the vehicle 100 into such lane while travelling in the same direction as the flow of traffic in that particular lane. In various embodiments, regardless of the selected lane of traffic, the processor 142 generates the automated exit path such that the vehicle 100 is travelling in the same direction as the flow of traffic into the selected lane.

In various embodiments, the process 200 then proceeds to step 220, described directly below.

In various embodiments, the automated exit path is implemented (step 218). In various embodiments, during step 218, the vehicle 100 exits the parking spot in an automated fashion into the selected lane of step 214 or 216 (whichever step is implemented during the process 200) while making the selected turn of the vehicle 100 such that the vehicle 100 is facing and travelling in the same direction as the traffic flow of the selected lane as the vehicle 100 enters the selected lane upon exiting the parking spot. In various embodiments, this is performed in accordance with the processor 142 of FIG. 1 that are implemented via the braking system 106, steering system 108, and/or drive system 110 of FIG. 1.

In various embodiments, the process 200 then terminates (step 220).

Accordingly, methods, systems, and vehicles are provided herein that provide for control of automated exit of the vehicle 100 from a parking spot into a selected lane of a roadway proximate the parking spot. In various embodiments, various types of sensor data, user inputs, and/or information is utilized for executing the automatic exit of the vehicle 100 from the parking spot into the selected lane such that the vehicle 100 is moving in the same direction as to the flow of traffic in the selected lane as the vehicle 100 moves into the selected lane upon exiting the parking spot.

It will be appreciated that the systems, vehicles, and methods may vary from those depicted in the Figures and described herein. For example, the vehicle 100 of FIG. 1, the control system 102, and/or components thereof may differ from that depicted in FIG. 1. It will similarly be appreciated that the steps of the processes and implementations of FIGS. 2-4 may differ from those depicted in the Figures, and/or that various steps may occur concurrently and/or in a different order than that depicted in the Figures.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for controlling an automated exit of a vehicle from a parking spot, the method comprising:
obtaining, via one or more sensors, sensor data pertaining to the parking spot in which the vehicle is parked and a plurality of lanes of a roadway in proximity to the parking spot, including a respective direction of flow of traffic for each of the plurality of lanes:
selecting, via one or more processors, a selected lane of the plurality of lanes for the vehicle to enter into upon exiting the parking spot, based at least in part on the sensor data, including the direction of flow of traffic of the selected lane:
selecting, via the one or more processors, a selected turn for the vehicle to make such that the vehicle is travelling in the same direction as the direction of flow of traffic of the selected lane as the vehicle enters the selected lane upon exiting the parking spot: and
executing, via instructions provided by the one or more processors, the automated exit of the vehicle from the parking spot into the selected lane by making the selected turn of the vehicle into the selected lane, such that the vehicle is moving in the direction of flow of traffic of the selected lane as it enters the selected lane.

2. The method of claim 1, wherein the steps of selecting the selected lane and selecting the selected turn are performed based at least in part on information as to typical traffic flows in the plurality of lanes, including a jurisdiction in which the vehicle is operated.

3. The method of claim 1, wherein the steps of selecting the selected lane and selecting the selected turn are performed based at least in part on inputs provided by a user of the vehicle pertaining to a type of parking spot in which the vehicle is parked, including a current angle and a current direction in which the vehicle is parked with respect to the roadway.

4. The method of claim 1, wherein the steps of selecting the selected lane and selecting the selected turn are performed based at least in part on inputs provided by a user of the vehicle pertaining to as to a preferred lane for the vehicle to enter upon exiting the parking spot.

5. The method of claim 1, wherein the steps of selecting the selected lane and selecting the selected turn are performed based at least in part on a geographic database stored in a computer memory as to the plurality of lanes of the roadway.

6. The method of claim 1, wherein:
the step of obtaining the sensor data comprises obtaining, via the one or more sensors, the sensor data comprising vision data as to the plurality of lanes; and
the steps of selecting the selected lane and selecting the selected turn are performed based at least in part on the vision data as to the plurality of lanes.

7. The method of claim 6, further comprising:
determining, via the one or more processors, the direction of flow of traffic of each of the plurality of lanes using the vision data.

8. The method of claim 6, further comprising:
determining, via the one or more processors, lane markings for the plurality of lanes from the vision data:
wherein the steps of selecting the selected lane and selecting the selected turn are performed based at least in part on the lane markings from the vision data.

9. The method of claim 6, further comprising:
identifying, via the one or more processors, traffic signs for the plurality of lanes from the vision data:
wherein the steps of selecting the selected lane and selecting the selected turn are performed based at least in part on the traffic signs from the vision data.

10. A system for controlling an automated exit of a vehicle from a parking spot, the system comprising:
one or more sensors configured to obtain sensor data pertaining to the parking spot in which the vehicle is parked and a plurality of lanes of a roadway in proximity to the parking spot, including a respective direction of flow of traffic for each of the plurality of lanes: and
one or more processors coupled to the one or more sensors and configured to at least facilitate:
selecting a selected lane of the plurality of lanes for the vehicle to enter into upon exiting the parking spot, based at least in part on the sensor data, including the direction of flow of traffic of the selected lane:
selecting a selected turn for the vehicle to make such that the vehicle is travelling in the same direction as the direction of flow of traffic of the selected lane as the vehicle enters the selected lane upon exiting the parking spot: and
executing, via instructions provided by the one or more processors, the automated exit of the vehicle from the parking spot into the selected lane by making the selected turn of the vehicle into the selected lane, such that the vehicle is moving in the direction of flow of traffic of the selected lane as it enters the selected lane.

11. The system of claim 10, wherein the one or more processors are further configured to at least facilitate selecting the selected lane and selecting the selected turn based at least in part on information as to typical traffic flows in the plurality of lanes, including a jurisdiction in which the vehicle is operated.

12. The system of claim 10, wherein the one or more processors are further configured to at least facilitate selecting the selected lane and selecting the selected turn based at least in part on inputs provided by a user of the vehicle pertaining to a type of parking spot in which the vehicle is parked, including a current angle and a current direction in which the vehicle is parked with respect to the roadway.

13. The system of claim 10, wherein the one or more processors are further configured to at least facilitate selecting the selected lane and selecting the selected turn based at least in part on inputs provided by a user of the vehicle pertaining to as to a preferred lane for the vehicle to enter upon exiting the parking spot.

14. The system of claim 10, wherein the one or more processors are further configured to at least facilitate selecting the selected lane and selecting the selected turn based at least in part on a geographic database stored in a computer memory as to the plurality of lanes of the roadway.

15. The system of claim 10, wherein:
the one or more sensors are configured to obtain the sensor data comprising vision data as to the plurality of lanes; and
the one or more processors are further configured to at least facilitate selecting the selected lane and selecting the selected turn based at least in part on the vision data as to the plurality of lanes.

16. The system of claim 15, wherein the one or more processors are further configured to at least facilitate determining the direction of flow of traffic of each of the plurality of lanes using the vision data.

17. The system of claim 15, wherein the one or more processors are further configured to at least facilitate:
identifying lane markings for the plurality of lanes from the vision data; and
selecting the selected lane and selecting the selected turn based at least in part on the lane markings from the vision data.

18. The system of claim 15, wherein the one or more processors are further configured to at least facilitate:
identifying traffic signs for the plurality of lanes from the vision data; and
selecting the selected lane and selecting the selected turn based at least in part on the traffic signs from the vision data.

19. A vehicle comprising:
a body:
a drive system configured to generate movement of the body:
one or more sensors disposed on or within the body and configured to obtain sensor data for the vehicle pertaining to a parking spot in which the vehicle is parked and a plurality of lanes of a roadway in proximity to the parking spot, including a respective direction of flow of traffic for each of the plurality of lanes; and
one or more processors that are disposed within the body and that is coupled to the one or more sensors, the one or more processors coupled to the one or more sensors and configured to at least facilitate:
selecting a selected lane of the plurality of lanes for the vehicle to enter into upon exiting the parking spot, based at least in part on the sensor data, including the direction of flow of traffic of the selected lane;
selecting a selected turn for the vehicle to make such that the vehicle is travelling in the same direction as the direction of flow of traffic of the selected lane as the vehicle enters the selected lane upon exiting the parking spot; and
executing, via instructions provided by the one or more processors, an automated exit of the vehicle from the parking spot into the selected lane by making the selected turn of the vehicle into the selected lane, such that the vehicle is moving in the direction of flow of traffic of the selected lane as it enters the selected lane.

20. The vehicle of claim 19, wherein the one or more processors are further configured to at least facilitate selecting the selected lane and selecting the selected turn based at least in part on information as to typical traffic flows in the plurality of lanes, including a jurisdiction in which the vehicle is operated.
